(19) United States
(12) Patent Application Publication
(10) Pub. No.: US 2013/0311827 A1
(43) Pub. Date: Nov. 21, 2013

(54) METHOD and APPARATUS for automatic testing of automation software

(71) Applicants: Tal Drory, Haifa (IL); Mattias Marder, Haifa (IL)

(72) Inventors: Tal Drory, Haifa (IL); Mattias Marder, Haifa (IL)

(73) Assignee: International Business Machines Corporation, Armonk, NY (US)

(21) Appl. No.: 13/472,493

(22) Filed: May 16, 2012

(51) Int. Cl. G06F 11/36

(52) U.S. Cl. 714/32; 714/E11.208

(57) ABSTRACT

A computer-implemented method and apparatus, the method comprising: receiving a test script indicating actions to be performed by automation software with regard to one or more elements of one or more processes; creating a simulation of the elements of the processes; activating the automation software; and testing activity of the automation software with regard to the simulation of the elements, thereby testing the automation software.

### TECHNICAL FIELD

The present disclosure relates to testing in general, and to a method and apparatus for testing automation software in particular.

### BACKGROUND

Computerized devices control almost every aspect of our life—from writing documents to controlling traffic lights. However, computerized devices and processes are bug-prone, and thus require a testing phase in which the bugs should be discovered. The testing phase is considered one of the most difficult tasks in designing a computerized device or a computer program.

Of particular interest are automation programs which control the activation or operation of other programs or processes. Such automation software may relate to computer desktop automation testing, controlling manufacturing processes, or others.

Computer automation software may operate on Graphic User Interface (GUI) of one or more programs, for example through the simulation of keystrokes, mouse events or other input events, which may be produced based on some screen image analysis technology, such as visual screen scraping. The automation software may simulate a human operator's actions when operating with any of the programs, usually by using its GUI. Such actions may include entering values into fields, clicking on buttons, and validating the presented content.

Such automation software, as any other software, may also contain bugs, and should itself be tested.

When trying to apply known automatic testing techniques in order to test computer automation software such as computer desktop automation software, some difficulties arise. For example, the objects used for testing, e.g. the test environment or the activated programs, may be affected by the automation software undergoing testing. For example the automation software may simulate clicking a button, and as a result of that a change, which may or may not be known or expected, may happen to the test environment or to any of the programs. For example, a new window may pop up, the screen resolution may change, or the like. Due to such changes, the rest of the automatic testing of the automation software cannot be executed as planned, resulting in a sequence of errors reported by the test.

It will also be appreciated that if the test environment exhibits complicated behavior, the repeatability of the tests of an automation software may be limited.

In addition, particularly when testing screen scraping technologies, it may be desired to test the automation software under a multitude of configurations, of the test environment or automation software. For example it may be required to test the system under varying fonts and font sizes, using different skins for the graphical look of the test environment, or the like, wherein the testing procedures should be repeated for each configuration. However, it may be difficult or may at least affect the efficiency of the automatic testing to reconstruct the test environment to a known state.

### BRIEF SUMMARY

One exemplary embodiment of the disclosed subject matter is a computer-implemented method performed by a computerized device, comprising receiving a test script indicating actions to be performed by an automation software with regard to one or more elements of one or more processes; creating a simulation of the elements of the processes; activating the automation software; and testing activity of the automation software with regard to the simulation of the elements, thereby testing the automation software.

Another exemplary embodiment of the disclosed subject matter is an apparatus having a processing unit and a storage device, the apparatus comprising: a testing framework generator for generating a testing framework for testing automation software; an element simulation component for creating a simulation in accordance with one or more elements of an one or more processes, indicated in a test script; an activation component for activating the automation software; and a testing component for monitoring activity of the automation software with regard to the simulation of the elements, thereby testing the automation software.

Yet another exemplary embodiment of the disclosed subject matter is a computer program product comprising: a non-transitory computer readable medium; a first program instruction for receiving a test script indicating actions to be performed by an automation software with regard to one or more elements of one or more processes; a second program instruction for creating a simulation of the elements of the processes; a third program instruction for activating the automation software; and a fourth program instruction for testing activity of the automation software with regard to the simulation of the elements, wherein said first, second and third program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic illustration of an automation software it is required to test;

FIG. 1B is a schematic illustration of a testing framework, in accordance with some exemplary embodiments of the disclosed subject matter;

FIG. 2 is a flowchart of steps in a method for automatic testing of a program in multiple configurations, in accordance with some exemplary embodiments of the disclosed subject matter; and

FIG. 3 shows a block diagram of components of an apparatus for automatic testing of a program in multiple configurations, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block or blocks of block diagrams.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is that given automation software that may be configured to simulate a person interacting with other programs, software, or other processes or elements such as graphic user elements thereof, the automation software itself has to be tested and verified for correct operation. In particular, there is a need to test computer desktop automation software which activates or operates other programs, for example using GUI. When testing automation software, different graphic characteristics or configurations of the environment may make it difficult to perform extensive testing, as the automation software has to repeat testing for all possible configurations. Additionally or alternatively, the behavior of the activated programs may affect or disturb, or even completely disable the continuation of the testing process.

Some known solutions include manual supervision of a user for testing a desktop automation tool. The manual verification may include actively watching the execution of the processes as operated by the automation software. Such testing process may include supervision instructions intended for the user, which relate to the actions to be executed by the automation software, and the expected outcome. However, such testing of the automation software is labor intensive and therefore slow and expensive. Moreover, it may be required to update all test schemes in use when the automation software is changed, which may introduce further errors.

Other types of solutions includes checking the end results of an automation process or of processes it activates, or verifying the image contents of screen shots taken during the execution of the automation process. Although these methods may be executed automatically, the expected results may highly depend on the particular graphical settings of the application, which are likely to vary between systems. In order to perform cross-platform or cross-configuration testing, a different set of screen shots may be stored for every set of graphic characteristics, and as part of testing the automation software, the test framework must verify that the initial screen state is identical or conform with (e.g. similar enough) a known state before the execution of each new test. This last condition can be particularly hard to guarantee if the test is executed on a computer that is generally in use, for example by a human user. The human operator might change graphical preferences, for example by opening a window, docking a sub window of an application to a new position, changing resolution, or the like.

A similar set of limitations may be applicable to automation software related for example to manufacturing processes, or any other automation program or process which may comprise hardware, software, a mechanical mechanism, a combination thereof, or the like.

It is thus required to develop tests that verify the functionality of the automation software under a multiplicity of configurations, without adding overhead to the development process, thus also enabling the testing on further configurations which may be realized at a later stage without further development overhead.

Another technical problem dealt with by the disclosed subject matter is the requirement for developing a testing solution for automation software that is reliable and robust in itself, and that does not depend on the reliability of the activated programs. Thus, if one or more of the processes activated by the automation software fails or otherwise malfunctions, testing should continue for the automation software.

Yet another technical problem dealt with by the disclosed subject matter is that the testing development process should be efficient so as not to add extra burden on the automation software developer.

One technical solution comprises the generation of a testing framework, which simulates the relevant behavior of the programs or processes activated by the automation software. For example, when the automation software is computer desktop automation software, the graphic behavior of the activated programs is simulated. The actions of the automation software, or its expected output are monitored or recorded by the automatically generated test GUI itself), thus testing the automation software without relying on the programs or processes it operates, and without considering the interrelationships between the automation software and the programs or processes.

The testing framework receives a test script defining the functionality of the testing software it is required to test, the graphical or other objects it is required to create and optionally some characteristics thereof, such as graphic characteristics. The testing framework may further receive a variety of environmental configurations or conditions, such as fonts, font sizes, screen resolutions, widget library, or the like.

The testing framework then optionally sets the environmental configuration, creates the required objects such as graphic objects using the required characteristics, activates the automation software such that the automation software operates on the created objects, and monitors the events fired by the automation software and the results output by the automation software. If particular sections of the test script require other graphic elements, the graphical elements are modified or destroyed and other elements may be created, and the tests of the relevant section of the script are performed. If testing for additional configurations is required, the testing framework may then continue to update the configuration, so that all required actions are tested for the required objects, and all relevant configurations.

It will be appreciated that a script describing the test iterations may or may not be included in the testing framework. If it is not included, then generic tests may be created using all or some of the range of the supplied parameters. The testing parameters (e.g. the range of font sizes, the fonts, the color set, or the like) are typically not a part of the script and may be supplied to the testing framework, either by the tester or a in the form of a default configuration as described above.

Testing may continue until all required tests have been performed, a specific failure has been recorded, any failure has been recorded, or any other stopping criterion has been met.

When testing the automation software, the testing framework captures the events or other actions performed by the automation software, and optionally its output. Since the testing framework receives from the testing script indications to the events or other actions that should be taken by the automation software or its output, the testing framework can thus compare the expected actions and output to the actual ones and determine whether the automation software functions correctly. The testing framework may log pass or fail information, as well as determine whether to continue execution of a longer test scheme after a fail or to stop testing.

The testing framework enables the testing of the automation software by simulating the objects the automation software is supposed to operate on, thus eliminating the reliance on the real objects and the programs that created them, and on the current configuration of the computing platform.

One technical effect of the disclosed subject matter relates to a method and apparatus for testing automation software by providing a testing framework for the automation software which, based on a testing script, simulates the programs or processes the automation software activates or operates, and monitors the activities, actions and output of the automation software to verify its operation. The method and apparatus provide for automatic and efficient testing of the automation software, and enables testing on a multiplicity of configurations without adding development overhead for additional testing.

Another technical effect of the disclosed subject matter relates to is providing a reliable and robust testing solution for automation software, which does not depend on the reliability or behavior of the activated programs.

Yet another technical effect of the disclosed subject matter relates to efficient development of testing for the automation software, wherein testing development adds only a relatively small burden to the automation software developer. This minimal burden is writing a testing script indicating the elements to be created, the expected actions, and the configurations the automation software is required to be tested upon.

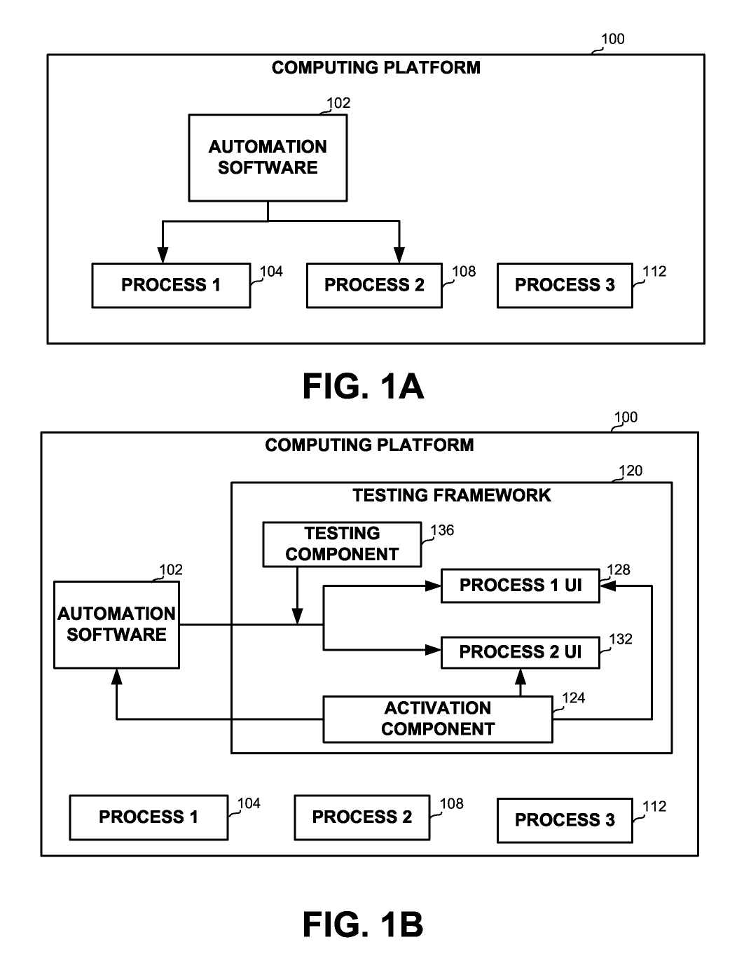

Referring now to FIG. 1A, showing a schematic illustration of an automation software that has to be tested, and to FIG. 1B showing a schematic illustration of a testing framework.

FIG. 1A shows a computing platform 100 and automation software 102 executed thereon. Automation software 102 may activate and may operate on process 1 (104) and process 2 (108) also executed on computing platform 100 or on another computing platform. Each of process 1 (104) and process 2 (108) may comprise graphic user interface with which automation software 102 interacts, for example by firing events such as mouse events, keyboard events to specific fields, or the like. It will be appreciated that additional processes such as process 3 (112) may also be executed on computing platform 100. Process 3 (112) may be non-related to the operation automation software 102. However, process 3 (112) may interfere with automation software 102, for example by creating windows which hide the GUI of process 1 (104) or process 2 (108), or in any other manner

It will be appreciated that computing platform 100 may operate under a specific configuration, including for example graphic configuration.

Since automation software 102 may contain bugs, it is required to test automation software 102. It may further be required to test automation software 102 under different conditions, such as other configurations of computing platform 100, the presence of additional processes such as process 3 (112), or the like.

Referring now to FIG. 1B, showing computing platform 100 and automation software 102 which has to be tested. In accordance with some embodiments of the disclosure, a testing framework 120 is created, optionally upon a testing script generated by the user or in any other manner The testing script may indicate that automation software 102 is to interact with process 1 (104) and process 2 (108). An activation component 124 of testing framework 120 generates the interfaces, e.g. graphic interfaces, for each process, thus generating process 1 User Interface (UI) (128) and process 2 UI (132). Activation component 124 may further activate automation software 102. Automation software 102 then operates on process 1 UI (128) and process 2 UI (132), instead of actual process 1 (104) and process 2 (108), each of which may or may not be executed by computing platform 100 or any other computing platform. Testing framework 120 may further comprise testing component 136 for monitoring the events and actions of automation software 102 and comparing them to the expected events and actions. Testing framework may also comprise components for setting the configuration of computing platform 100, for analyzing the events or output of automation software 102, and for determining the work flow, for example determining whether or not automation software 102 should continue, e.g., after a failure or a bug has been discovered.

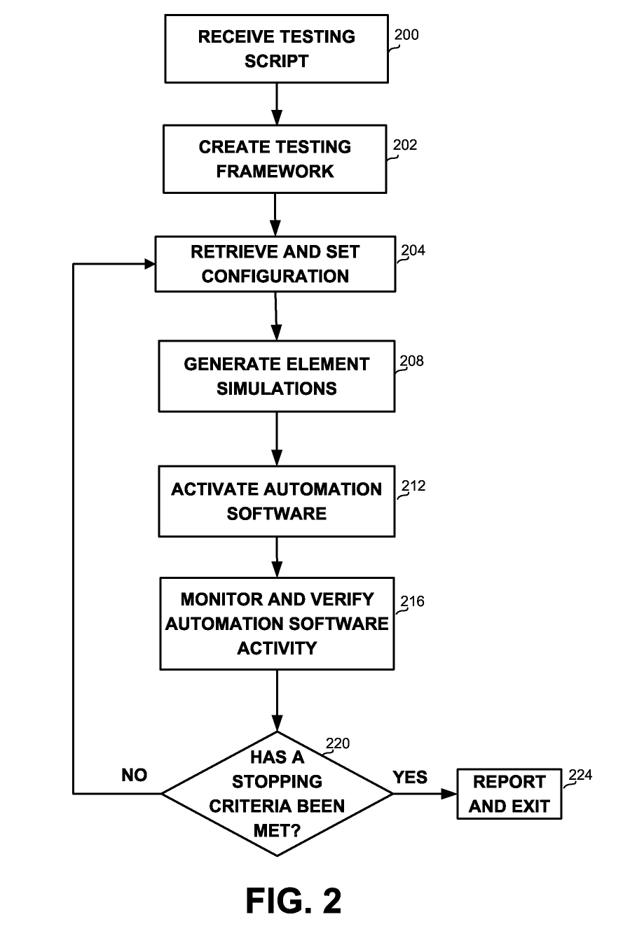

Referring now to FIG. 2, showing a flowchart of steps in a method for automatically testing automation software.

On step 200 the method may receive a testing script for testing an automation server. The test script may indicate the processes with which the automation software has to interact, and optionally high level description of the elements with which it is required to interact within each process, such as a data field X or a button Y. For example, when simulating activating a calculator, a window containing a collection of buttons carrying digits and operators as well as a text box may be generated. It may be indicated that the automation software is to send one or more keyboard events to the data field, click one or more buttons, or the like. The testing script may also indicate one or more aspects related to configurations of the host computer, under which the automation software is to be tested, for example aspects related to communication, hardware, users, permissions, or the like. The testing script may comprise commands or instructions related to configurations such as but not limited to Add_Test_Font which receives a font name; Add_Test_Font_Size_Range which receives a minimal and maximal font size to be set; Add_Test_Widget which receives components to be used such as one or more buttons, drop downs, lists, check boxes, or the like; Add_Test_Widget_Library which may receive the styles to be used for graphical components such as buttons or others; Add_Test_Window_Skin which may receive the operating systems graphical look to be used; Add_Test_Language which may receive a character set to include in the tests; Use_Color_Cobinations which may receive color combinations of the text and background to be used, or the like.

It will be appreciated that when a new configuration is to be tested, all the test developer has to do is add the configuration description to the test script, so that the automation software is tested also on the new configuration.

On step 202, a testing framework may be created and may receive as input the testing script. In some alternative embodiments, a generic testing framework may be created, which then retrieves or receives the testing script.

On step 204, the testing framework may optionally retrieve from the testing script a configuration of the computing platform on which the automation software is to run, and set the computing platform to that configuration. If no configuration is indicated in the testing script, the computing platform configuration may be left as is, or a default configuration may be assumed.

On step 208, the testing framework may generate simulations of the elements of the processes with which the automation software is to interact with, in accordance with the received testing script. For example, graphic user interface elements may be created which may include windows, buttons, text boxes or other elements.

On step 212 the automation software may be activated, and may receive pointers or other indications to the graphic elements created on step 208, or an association between the graphic elements and the elements with which the automation software is supposed to interact.

On step 216 the activity of the automation software may be intercepted and verified. Interception can be achieved by having components of the testing GUI log any action applied to them. Thus if the mouse is used to move to a control, and a click event is executed by the automation software undergoing testing, that event is recorded and compared to the expected behavior. Activity may relate to events fired by the automation software. In addition, the output produced by the automation software, such as created or modified files, side effects, or others, may be examined. The testing framework may obtain from the testing script the expected events and outputs, and can thus verify the correctness of the actual events and output.

Each event or output may be recorded, optionally with a pass/fail indication, related to whether the events or output meet the expected results. For example: “Test 1, configuration 2: Expected: mouse event at coordinates (x, y); Received: mouse event at coordinates (x, y); Result: pass” or “Test 2, configuration 3: Expected: text at text box “Welcome John”; Received: text at text box “Welco e Jom”; Result: fail”.

In some embodiments, the automation software may not produce the required event, or it may produce no event at all, which may result in endless waiting. A timeout mechanism after which the testing framework continues even if no event or a wrong event was received may eliminate such situation. In the case of timeout, the current test iteration can be set to “fail”, and may be terminated, or the next instruction of the current test iteration can be executed in order to gather additional information.

It will be appreciated that step 208, 212 and 216 may be repeated for additional tests, for example tests that require other elements, tests that should be repeated under different conditions, or the like.

On step 220 it may be determined whether a stopping criterion has been met. A stopping criteria may be but is not limited to any one or more of the following: a failure of the automation software to produce any event or output; an undesired event or output produced by the automation software; a particular problem or mismatch in the events or output produced by the automation software; at least a predetermined number of any problems or failures of the automation software; failure to set the computing platform to a particular configuration; all tests indicated in the script have been performed for all required configurations; all tests indicated in the script have been performed for all configurations to which the computing platform could be set; a predetermined testing time has passed; or the like.

If a stopping criterion has been met, the testing framework may issue a report or may otherwise output the results, and exit.

If no stopping criterion has been met, the testing framework may return to step 204, retrieve and set the next configuration, and continue as detailed above. Thus, the automation software may be activated to perform the testing for each configuration, and even if a particular test fails, the testing framework may re-initialize and prepare for the next configuration in the testing scheme, thus allowing to robustly test the automation software under multiple configurations.

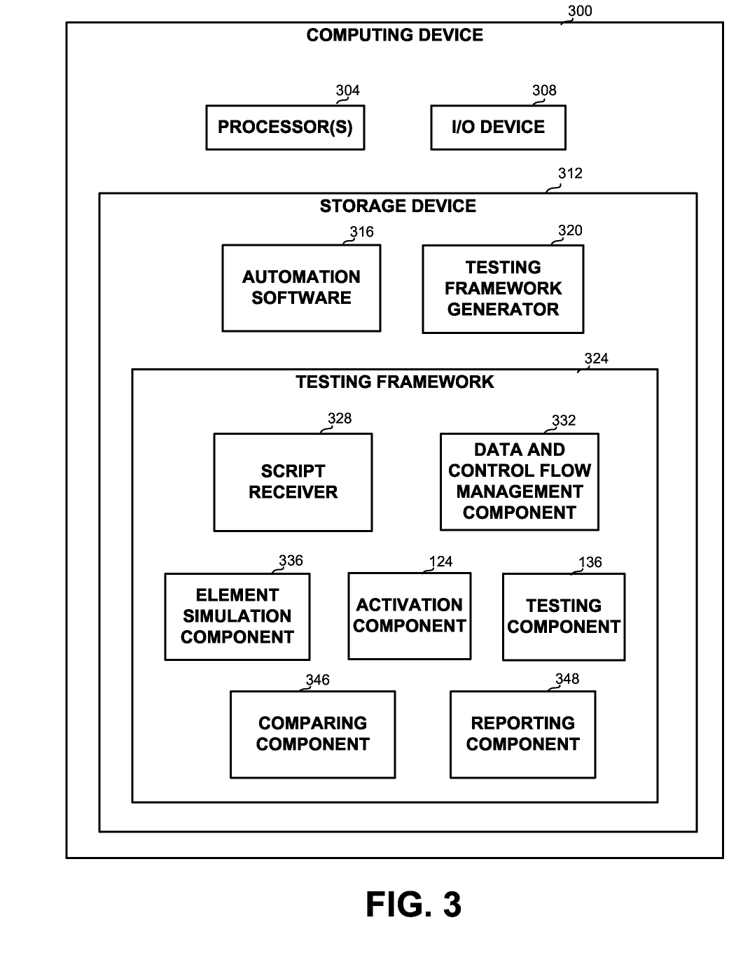

Referring now to FIG. 3, showing a block diagram of components of an apparatus for testing transactions.

The environment comprises a computing device 300, which may comprise one or more processors 304. Any of processors 304 may be a Central Processing Unit (CPU), a microprocessor, an electronic circuit, an Integrated Circuit (IC) or the like. Alternatively, computing device 300 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 304 may be utilized to perform computations required by computing device 300 or any of its subcomponents.

In some embodiments, comptuing device 300 may comprise an input-output (I/O) device 308 such as a terminal, a display, a keyboard, an input device or the like to interact with the system, to invoke the system and to receive results. It will however be appreciated that the system can operate without human operation and without I/O device 308.

Comptuing device 300 may comprise one or more storage devices 312 for storing executable components, and which may also contain data during execution of one or more components. Storage device 312 may be persistent or volatile. For example, storage device 312 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 312 may retain program code operative to cause any of processors 304 to perform acts associated with any of the steps shown in FIG. 2 above, for example determining configurations, setting a configuration, executing the tested program, or the like.

The components detailed below may be implemented as one or more sets of interrelated computer instructions, loaded to storage device 312 and executed for example by any of processors 304 or by another processor. The components may be arranged as one or more executable files, dynamic libraries, static libraries, methods, functions, services, or the like, programmed in any programming language and under any computing environment.

In some embodiments the loaded components may include automation software 316, which it is required to check, and testing framework generator 320. Upon activation, testing framework generator 320 generates and activates testing framework 324 which may also be loaded to storage device 312.

Testing framework 324 may comprise script receiver 328 which may receive a script associated with automation software 316 and which may indicate how automation software 316 is to be tested and under what configurations. It will be appreciated that script receiver 328 may be external to testing framework 328 and may be received by testing generator 320 for generating testing framework 324.

Testing framework 324 may comprise data and control flow management component 332 for handling the testing flow by activating components of testing framework 324, tracking input and output, managing the control flow, determining whether a stopping criteria has been met, or the like, for example in accordance with the method detailed in association with FIG. 2 above.

Testing framework 324 may further comprise element simulation component 336 for creating graphic or other elements required by the testing script, such as windows, buttons, text boxes, drop down lists, or the like.

Yet another component of testing framework 324 may be activation component 124 responsible for activating automation software 316 and communicating to automation software 316 the graphic elements generated by element simulation component 336.

Testing framework 324 may further comprise testing component 136 for intercepting events fired by automation software 316, and comparing component 346 for verifying that the events intercepted by testing component 136 are the same as the expected events. Comparing component 346 may be implemented as part of testing component 136.

Yet another component of testing framework 324 may be reporting component 348 for reporting the testing results of automation software 316, possibly by indicating were execute, passed, failed, or the like.

The disclosed method and apparatus provide for automatically testing automation software under a variety of configurations with little burden on the test developer. The method and apparatus provide for efficiently repeating texts for different configurations, in a reliable and robust manner which does not depend on the reliability or behavior of the activated programs.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like, conventional procedural programming languages, such as the “C” programming language or similar programming languages, scripting languages such as Perl, Python, Ruby, or any other programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a test script indicating actions to be performed by an automation software with regard to at least one element of at least one process;
creating a simulation of the at least one element of the at least one process;
activating the automation software; and
testing activity of the automation software with regard to the simulation of the at least one element,
thereby testing the automation software.

2. The computer-implemented method of wherein testing the activity of the automation software with regard to the simulation of the at least one element is performed by comparing expected effect of the automation software on the simulation, with activities recorded by the simulation.

3. The computer-implemented method of claim 1, further comprising generating a testing framework adapted to perform said creating, activating and monitoring.

4. The computer-implemented method of claim 1, wherein the test script comprises indication of at least one configuration aspect of the computerized device, and wherein the testing framework sets the computerized device in accordance with the at least one configuration aspect.

5. The computer-implemented method of claim 1, wherein testing the activity comprises the simulation software intercepting events fired by the automation software.

6. The computer-implemented method of claim 1, wherein testing the activity comprises receiving output of the automation software or the simulation software.

7. The computer-implemented method of claim 1, further comprising determining whether a stopping criterion has been met.

8. The computer-implemented method of claim 7, wherein the stopping criteria is selected from the group consisting of: a failure of the automation software to produce any event or output; an undesired event or output produced by the automation software; a mismatch in an event or output produced by the automation software; at least a predetermined number of problems or failures of the automation software; failure to set the computing platform to a configuration; all tests indicated in the script have been performed for all required configurations; all tests indicated in the script have been performed for all configurations to which the computing platform could be set; and a predetermined testing time has passed.

9. The computer-implemented method of claim 1, further comprising reporting events or output of the automation software.

10. The computer-implemented method of claim 1, further comprising reporting whether an event or output of the automation software constitutes an expected event or output.

11. The computer-implemented method of claim 1, wherein the at least one element is a graphic user interface element, and wherein the automation software is configured to simulate a person interacting with the at least one element.

12. An apparatus having a processing unit and a storage device, the apparatus comprising:
a testing framework generator for generating a testing framework for testing automation software;
an element simulation component for creating a simulation in accordance with at least one element of an at least one process, indicated in a test script;
an activation component for activating the automation software; and
a testing component for monitoring activity of the automation software with regard to the simulation of the at least one element,
thereby testing the automation software.

13. The apparatus of claim 12, wherein said element simulation component, activation component and testing component are comprised within a testing framework generated by the testing framework generator.

14. The apparatus of claim 12, wherein the test script comprises indication of at least one configuration aspect of the computerized device, and wherein the testing framework is adapted to set the computerized device in accordance with the at least one configuration aspect.

15. The apparatus of claim 12, wherein the testing component intercepts events fired by the automation software.

16. The apparatus of claim 12, wherein the testing component receives output of the automation software

17. The apparatus of claim 12, further comprising a comparing component for comparing events or output by the automation software to expected events or output.

18. The apparatus of claim 12, further comprising a data and control flow management component for determining whether a stopping criterion has been met.

19. The apparatus of claim 18, wherein the stopping criteria is selected from the group consisting of: a failure of the automation software to produce any event or output; an undesired event or output produced by the automation software;
a mismatch in an event or output produced by the automation software; at least a predetermined number of problems or failures of the automation software; failure to set the computing platform to a configuration; all tests indicated in the script have been performed for all required configurations; all tests indicated in the script have been performed for all configurations to which the computing platform could be set; and a predetermined testing time has passed.

20. The apparatus of claim 12, further comprising a reporting component for reporting events or output of the automation software or whether an event or output of the automation software constitutes an expected result.

21. The apparatus of claim 12, wherein the at least one element is a graphic user interface element, and wherein the automation software is configured to simulate a person interacting with the at least one element.

22. A computer program product comprising:
a non-transitory computer readable medium;
a first program instruction for receiving a test script indicating actions to be performed by an automation software with regard to at least one element of at least one process;
a second program instruction for creating a simulation of the at least one element of the at least one process;
a third program instruction for activating the automation software; and
a fourth program instruction for testing activity of the automation software with regard to the simulation of the at least one element,
wherein said first, second, third and fourth program instructions are stored on said non-transitory computer readable medium.
